(19) United States
(12) Patent Application Publication
(10) Pub. No.: US 2024/0326191 A1
(43) Pub. Date: Oct. 3, 2024

(54) PROCESSING DISCHARGE LIQUID FILTRATION DEVICE

(71) Applicant: TOKYO SEIMITSU CO., LTD., Tokyo (JP)

(72) Inventors: Tenta TUBOI, Tokyo (JP); Naomune TANIGUTI, Tokyo (JP)

(21) Appl. No.: 18/607,514

(22) Filed: Mar. 17, 2024

(30) Foreign Application Priority Data
Mar. 27, 2023 (JP) 2023-049830

(51) Int. Cl. B23Q 11/10; B23Q 11/00

(52) U.S. Cl. CPC B23Q 11/1069; B23Q 11/0057

(57) ABSTRACT

A processing discharge liquid filtration device enhances filtration capacity for filtering a discharge liquid discharged from a processing device. The processing discharge liquid filtration device includes a dirty tank that stores a discharge liquid containing cutting chips, a dirty tank pump that pumps the discharge liquid stored in the dirty tank to a screen filter for primary filtration processing that recovers the cutting chips mixed into the discharge liquid, and a cutting chip recovery container that contains the cutting chips recovered by the screen filter. The processing discharge liquid filtration device eliminates the time and effort to replace the filtration member or filter and keeps the quality of the filtered discharge liquid constant.

### FIELD OF THE INVENTION

The present invention relates to a processing discharge liquid filtration device that filters and discharges a discharge liquid such as a grinding liquid to be discharged from a processing device such as a grinding device.

### BACKGROUND OF THE INVENTION

In a semiconductor device manufacturing process, for example, a semiconductor wafer, composed of silicon, a compound semiconductor, or the like, having a large number of devices formed therein is cut and divided along a to-be-divided line as a boundary between the devices, to obtain individual semiconductor devices. The semiconductor devices thus manufactured are widely used for various types of electronic equipment such as a mobile phone and a personal computer. However, in recent years, a stacked device configured such that the semiconductor devices can be stacked has been developed to enable a reduction in size and weight of this type of electronic equipment.

The stacked device has been subjected to processing for forming a projection-shaped electrode called a bump on a surface of the semiconductor device, embedding an underfill material composed of epoxy resin or the like in the bump, and then cutting the bump, together with the underfill material, using cutting processing to expose the bump to a surface of the underfill material. To thus subject the bump or the resin to cutting processing, a fly cutting device having a form of rotating a bite wheel having a cutting edge and cutting the bump using the cutting edge while supplying a grinding liquid (e.g., cooling water such as pure water) to an object to be processed held in a holding table, for example, has been used (see, e.g., Patent Literatures 1 and 2). A method for recovering a grinding liquid used for grinding processing from a processing chamber where a grinding device is installed and filtering and discharging the grinding liquid has been adopted.

In cutting resin or a metal using the above-described grinding device, when the resin or the metal has a viscosity and a viscosity occurs due to heat generation at the time of processing, processing chips, i.e., cutting chips may be generated as a form of thread. A discharge liquid containing the cutting chips is stored in a precipitation tank in a processing chamber once, and the processing chips are precipitated to collect the large cutting chips and discharge the small cutting chips as they are.

### CITATION LIST

### Patent Literature

[Patent Literature 1] Japanese Patent Laid-Open No. 2014-18942
[Patent Literature 2] Japanese Patent Laid-Open No. 2022-35272

### Technical Problem

However, when the precipitation tank is directly provided with a filter, the filter is clogged with the cutting chips as described above because a discharge amount of the cutting chips is large, and needs to be maintained at a high frequency. In the precipitation tank, there is no effect of collecting suspended matter in the liquid and on a liquid surface. Accordingly, lightweight resin or the like may flow out to a drain line outside the processing chamber as it is and clog the drain line. Conventionally, a drain trap of a Y strainer type may have been only used for the drain line, thereby presenting problems that the drain line is immediately clogged and needs to be frequently maintained, resulting in poor productivity.

There occurs a technical problem to be solved to provide a processing discharge liquid filtration device capable of enhancing a filtration capacity for filtering a discharge liquid to be discharged from inside a processing chamber to eliminate a time and effort required to replace a filtration member (filter) and keeping the quality of the filtered discharge liquid constant, and the present invention has its object to solve this problem.

### SUMMARY OF THE INVENTION

### Solution to Problem

The present invention has been proposed to attain the above-described object. An embodiment provides a processing discharge liquid filtration device that filters a discharge liquid containing cutting chips discharged from a processing device, the processing discharge liquid filtration device including a first tank that stores the discharge liquid, a first tank pump that pumps up the discharge liquid stored in the first tank, a screen filter for primary filtration processing that recovers the cutting chips mixed into the discharge liquid to be supplied from the first tank pump, and a cutting chip recovery container that contains the cutting chips recovered by the screen filter.

According to this configuration, the discharge liquid discharged from the processing device is stored in the first tank once, and is then supplied onto the screen filter for primary filtration processing by the first tank pump. The cutting chips mixed into the discharge liquid are collected by the screen filter and are recovered into the cutting chip recovery container, and the discharge liquid that has passed through the screen filter is discharged out of the first tank. The cutting chips collected by the screen filter can be automatically recovered into the cutting chip recovery container from the screen filter, thereby eliminating the need to maintain the screen filter at a high frequency.

The discharge liquid agitation means returns a part of the discharge liquid pumped up from inside the first tank by the first tank pump into the discharge liquid in the first tank, to agitate the discharge liquid in the first tank by the flow of the returned discharge liquid. By this agitation, lightweight resin or the like to be collected on a liquid surface is drawn into the liquid, the cutting chips to be accumulated at a bottom of the first tank are suspended in the liquid, and the discharge liquid containing the cutting chips by being agitated is supplied onto the screen filter by the first tank pump, thereby enhancing the quality of a filtration performance, for example.

Another embodiment provides, that the processing discharge liquid filtration device further including discharge liquid agitation means for returning a part of the discharge liquid pumped up by the first tank pump into the discharge liquid in the first tank to agitate the discharge liquid in the first tank.

According to this configuration, the discharge liquid agitation means returns a part of the discharge liquid pumped up from inside the first tank by the first tank pump into the discharge liquid in the first tank, to agitate the discharge liquid in the first tank by the flow of the returned discharge liquid. By this agitation, lightweight resin or the like to be collected on the liquid surface is drawn into the liquid, the cutting chips to be accumulated at the bottom of the first tank are suspended in the liquid, and the discharge liquid containing the cutting chips by being agitated is supplied onto the screen filter by the first tank pump, thereby enhancing the quality of a filtration performance, for example.

Another embodiment provides, that the processing discharge liquid filtration device further including a pump cooling flow path that showers a part of the discharge liquid pumped up by the first tank pump onto an outer surface of the first tank pump.

According to this configuration, a part of the discharge liquid pumped up by the first tank pump is cooled by being showered onto the outer surface of the first tank pump to suppress a rise in temperature in the first tank pump during operation, thereby enabling continuous operation over a long time period.

Another embodiment provides, that the processing discharge liquid filtration device further including a sensor that detects an amount of the discharge liquid in the first tank, and a control unit that controls operation and stop of the first tank pump on the basis of a signal from the sensor.

According to this configuration, the sensor detects the amount of the discharge liquid in the first tank, and the control unit controls the operation and the stop of the first tank pump on the basis of the signal from the sensor, thereby making it possible to keep the amount of the discharge liquid in the first tank substantially constant.

Another embodiment provides, that the processing discharge liquid filtration device further including a second tank that stores the discharge liquid, which has been subjected to the primary filtration processing, to be discharged from the first tank side, a back filter for secondary filtration processing that passes the discharge liquid stored in the second tank and recovers the very small cutting chips mixed into the discharge liquid, and a second tank pump that pumps up the discharge liquid stored in the second tank and supplies the discharge liquid to the upstream side of the back filter.

According to this configuration, the discharge liquid discharged from the first tank side through the screen filter is stored in the second tank once, and is then supplied onto the back filter for secondary filtration processing by the second tank pump. The very small cutting chips mixed into the discharge liquid are further collected by the back filter, and the discharge liquid that has passed through the screen filter is discharged out of the second tank. Therefore, the very small cutting chips contained in the discharge liquid, which has been subjected to primary filtration processing, to be discharged from the first tank side are further collected by the back filter, and the discharge liquid that has passed through the back filter is further discharged out of the second tank as a clean discharge liquid. As a result, the quality of the filtered discharge liquid is further improved.

Another embodiment provides, that the processing discharge liquid filtration device further including a sensor that detects an amount of the discharge liquid in the second tank, and a control unit that controls stop of operation of the second tank on the basis of a signal from the sensor.

According to this configuration, the sensor detects the amount of the discharge liquid in the second tank, and the control unit controls operation and stop of the second tank pump on the basis of the signal from the sensor, thereby making it possible to keep the amount of the discharge liquid in the second tank substantially constant.

Another embodiment provides, that the processing discharge liquid filtration device further including a discharge liquid return line that returns the discharge liquid in the second tank to the first tank when an amount of the discharge liquid in the second tank exceeds a predetermined amount.

According to this configuration, when the amount of the discharge liquid in the second tank exceeds the predetermined amount, the discharge liquid corresponding to an excess amount is returned to the first tank side from inside the second tank through the discharge liquid return line. Therefore, when the amount of the discharge liquid in the second tank is the predetermined amount or more due to any inconvenience, the discharge liquid corresponding to an excess amount is automatically returned to the inside of the first tank, thereby making it possible to simplify management of the amount of the discharge liquid in the second tank.

Another embodiment provides, that the processing discharge liquid filtration device in which the back filter includes filters in a plurality of stages that filter and sequentially pass the discharge liquid, and the filters in the stages are respectively configured to be independently replaceable.

According to this configuration, the back filter includes the filters in the plurality of stages that are independently replaceable, resulting in a simplification in work for replacing the filters. The back filter can be replaced without stopping the work. This results in an improvement in productivity.

### Advantageous Effect of Invention

According to the present invention, cutting chips collected by a screen filter can be automatically recovered into a cutting chip recovery container from the screen filter, and the screen filter need not be maintained at a high frequency, resulting in an improvement in productivity. It is possible to enhance a filtration capacity for filtering a discharge liquid to be discharged from inside a processing chamber to eliminate a time and effort required to replace a filtration member (filter) and to also keep the quality of the filtered discharge liquid constant.

### BRIEF DESCRIPTION OF DRAWINGS

FIG. 1 is a schematic configuration diagram of a filtration system to which a processing discharge liquid filtration device according to the present invention is applied.

FIG. 2 is a block diagram illustrating an example of a control system that controls operation and stop of a dirty tank pump and a clean tank pump in the filtration system.

### DESCRIPTION OF THE PREFERRED EMBODIMENTS

To attain an object to provide a processing discharge liquid filtration device capable of enhancing a filtration capacity for filtering a discharge liquid to be discharged from a processing device to eliminate a time and effort required to replace a filtration member (filter) and keeping the quality of the filtered discharge liquid constant, the present invention implements a processing discharge liquid filtration device that filters a discharge liquid containing cutting chips discharged from a processing device by including a first tank that stores the discharge liquid, a first tank pump that pumps up the discharge liquid stored in the first tank, a screen filter for primary filtration processing that recovers the cutting chips mixed into the discharge liquid to be supplied from the first tank pump, and a cutting chip recovery container that contains the cutting chips recovered by the screen filter.

An example of an embodiment of the present invention will be described in detail below with reference to the accompanying drawings. In the following example, when reference is made to the number of components or a numerical value, amount, range, or the like of each of the components, the number or the like is not limited to a particular number but may be the particular number or more or the particular number or less unless otherwise stated or except when expressly limited to the particular number in principle.

When reference is made to a shape of each of components and a positional relationship among the components, a substantially approximate or similar shape or the like is included unless otherwise stated or except when considered to be expressly excluded in principle.

In the drawings, characteristic portions may be exaggerated by being enlarged, for example, in order to facilitate the understanding of features, and a dimension ratio or the like of each of the components is not necessarily the same as an actual one. In a cross-sectional view, hatching of some of the components may be omitted in order to facilitate the understanding of a cross-sectional structure of the components.

In the following description, terms representing directions such as up-down and left-right directions are not absolute, but are appropriate if each of sections in a processing discharge liquid filtration device according to the present invention is in a depicted orientation. However, if the orientation has changed, the terms should be construed by being changed depending on the change in the orientation. Throughout the entire description of the example, the same elements are respectively denoted by the same reference numerals.

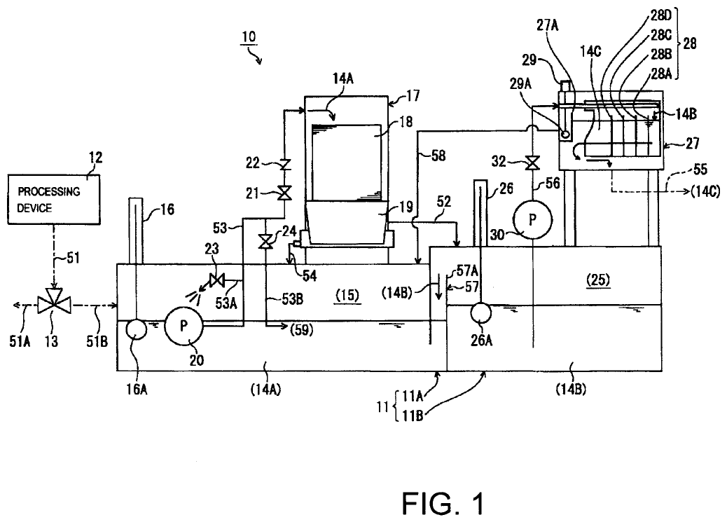

FIG. 1 is a schematic configuration diagram of a filtration system 10 to which a processing discharge liquid filtration device 11 according to the present invention is applied. In FIG. 1, the filtration system 10 includes a processing chamber 12 where a processing device is installed and a processing discharge liquid filtration device 11 that filters a discharge liquid to be discharged from the processing chamber 12 and feeds the discharge liquid as a clean discharge liquid. The processing device is a grinding device, a fly cutting device, or the like that presses a tool for cutting or grinding against a plate-shaped object to be processed, which is represented by a semiconductor wafer or a package substrate, for example, to form a flat surface. In this processing device, processing chips, i.e., cutting chips are generated in large amounts. The cutting chips, together with a cleaning fluid, are washed away by ejecting the cleaning fluid toward a region-to-be-processed of the object to be processed such that they can be appropriately removed, and are discharged out of the processing chamber 12 as a discharge liquid. A cleaning device that separates the cutting chips contained in the discharge liquid from the discharge liquid and discharges the discharge liquid with the cutting chips eliminated out of a factory, for example, is the processing discharge liquid filtration device 11 here. The discharge liquid here includes at least a liquid such as water. However, the specific type or the like of the liquid is not particularly limited. The type of the processing device is not particularly limited.

A three-way valve 13 is provided in the middle of a flow path 51 that connects the processing chamber 12 and the processing discharge liquid filtration device 11. The three-way valve 13 is a valve capable of alternately switching a flow path 51A that causes a discharge liquid 14A to be discharged from the processing chamber 12 to flow into the processing discharge liquid filtration device 11 and a flow path 51B that does not cause the discharge liquid 14A to flow into the processing discharge liquid filtration device 11 but directly discharges the discharge liquid 14A to the outside from the processing chamber 12. That is, in the three-way valve 13, the flow path is switched, whereby a discharge liquid that need not be filtered can be directly discharged to the outside through the flow path 51A from the middle of the flow path 51. However, when a discharge liquid with cutting chips eliminated is discharged out of a factory, for example, using the processing discharge liquid filtration device 11, the flow path 51B is selected.

The processing discharge liquid filtration device 11 includes a dirty filtration section 11A and a clean filtration section 11B. The dirty filtration section 11A is a section that collects relatively large cutting chips mixed into the discharge liquid 14A discharged from the processing chamber 12 to perform primary filtration processing and feeds a discharge liquid 14B, which has been subjected to the primary filtration processing, toward the clean filtration section 11B. On the other hand, the clean filtration section 11B is a section that further collects relatively small cutting chips mixed into the discharge liquid 14B subjected to the primary filtration processing through the dirty filtration section 11A to perform secondary filtration processing and discharges a clean discharge liquid 14C, which has been subjected to the secondary filtration processing, to the outside. Therefore, when the very small cutting chips need not be processed, only the dirty filtration section 11A may be installed, and the clean filtration section 11B may be omitted. However, in the present embodiment, the following description will be made as a case where both the dirty filtration section 11A and the clean filtration section 11B are required.

The dirty filtration section 11A is provided with a dirty tank (first tank) 15 that stores the discharge liquid 14A before processing to be discharged from the processing chamber 12. The dirty filtration section 11A is provided with a float switch 16 having a float 16A as a sensor that detects a liquid amount of the discharge liquid 14A stored in the dirty tank 15. The float switch 16 floats the float 16A on a liquid surface of the discharge liquid 14A in the dirty tank 15, detects whether or not the liquid amount of the discharge liquid 14A remains to be a determined liquid amount or less or the liquid amount or more, and outputs its detection signal.

A primary filtration section 17 is provided above the dirty tank 15. The primary filtration section 17 includes a screen filter 18 and a cutting chip recovery container 19 that contains cutting chips or the like collected by the screen filter 18. The screen filter 18 has been well known, and is installed with a wire screen having flat plate-shaped fine stitches (e.g., stitches having an opening of approximately 100 um therebetween) greatly inclined (by 45 degrees) downward from above. The cutting chip recovery container 19 is installed at a lower end down the screen filter 18. The screen filter 18 is good in dehydration, is difficult to clog because the cutting chips drop, and can be maintained at a low frequency. In the primary filtration section 17, when the discharge liquid 14A in the dirty tank 15 is fed onto the screen filter 18 and is caused to flow, the coarse cutting chips mixed into the discharge liquid 14A are collected on the screen filter 18, and the discharge liquid 14B from which the coarse cutting chips (large cutting chips) are removed is fed toward the clean filtration section 11B through a flow path 52. The coarse cutting chips collected on the screen filter 18 are set to be recovered by slipping down into the cutting chip recovery container 19 arranged below by the inclination of the screen filter 18.

In the dirty tank 15, there is provided a dirty tank pump (first tank pump) 20 that supplies the discharge liquid 14A stored in the dirty tank 15 onto the screen filter 18 in the primary filtration section 17 through a flow path 53. The dirty tank pump 20 can suck a mass of processing chips (cutting chips) to be generated from the processing device such as the grinding device or the fly cutting device, for example. The dirty tank pump 20 is a cutter pump in the present embodiment, for example, a model number 50C2.75-64 manufactured by TSURUMI MANUFACTURING CO., LTD. The dirty tank pump 20 is operated and stopped under control of a control unit 50 that performs control on the basis of an on-off signal from the sensor (float switch) that detects the liquid amount of the discharge liquid 14A in the dirty tank 15. The control of the operation and the stop by the control unit 50 makes it possible to keep the liquid amount of the discharge liquid 14A in the dirty tank 15 substantially constant.

The flow path 53 has a branch flow path 53A and a branch flow path 53B provided in its middle. An open-close valve 21 and a check valve 22 are provided between the primary filtration section 17 and the branch flow paths 53A and 53B.

The branch flow path 53A is a pump cooling flow path that showers a part of the discharge liquid 14A flowing in the flow path 53 onto an outer surface of the dirty tank pump 20 and passes the discharge liquid 14A for cooling the inside of the dirty tank pump 20, and has an open-close valve 23 provided in its middle. The open-close valve 23 is controlled to be opened and closed by the control unit 50, described below. Here, the open-close valve 23 is opened when an internal temperature of the dirty tank pump 20 is a predetermined temperature or more, to cool the dirty tank pump 20 by showering the discharge liquid 14A through the branch flow path 53A. On the other hand, the open-close valve 23 is closed when the internal temperature of the dirty tank pump 20 is the predetermined temperature or less.

The branch flow path 53B is a flow path that returns a part of the discharge liquid 14A flowing in the flow path 53 into the discharge liquid 14A in the dirty tank 15, and has an open-close valve 24 provided in its middle. A spray port on the side of a distal end of the branch flow path 53B is extended to a liquid intermediate layer that stores the discharge liquid 14A in the dirty tank 15, to constitute discharge liquid agitation means 59 for returning the discharge liquid 14A into the liquid intermediate layer from the spray port at the distal end of the branch flow path 53B to agitate the entire discharge liquid 14A in the dirty tank 15 by the flow of the discharge liquid 14A to be returned. The agitation in the dirty tank 15 by the discharge liquid agitation means 59 makes it easy for the dirty tank pump 20 to suck the cutting chips into the flow path 53 by drawing lightweight resin or the like to be collected on the liquid surface of the discharge liquid 14A into the liquid while suspending the heavy cutting chips submerged on a bottom surface of the dirty tank 15 in the dirty tank 15.

An opening and closing operation of the open-close valve 21 in the flow path 53 and an opening and closing operation of the open-close valve 24 in the branch flow path 53B are controlled by the control unit 50, described below. The primary filtration section 17 is provided with a flow path 54 that returns the discharge liquid 14B, which has not caused to flow toward the clean filtration section 11B from the flow path 52, into the dirty tank 15.

The clean filtration section 11B is provided with a clean tank (second tank) 25 that stores the discharge liquid 14B, which has been subjected to primary filtration processing, to be discharged from the dirty filtration section 11A through the flow path 52. The clean filtration section 11B is provided with a float switch 26 having a float 26A as a sensor that detects a liquid amount of the discharge liquid 14B stored in the clean tank 25. The float switch 26 floats the float 26A on a liquid surface of the discharge liquid 14B in the clean tank 25, detects whether or not the liquid amount of the discharge liquid 14B remains to be a determined liquid amount or less or the liquid amount or more, and outputs its detection signal.

A secondary filtration section 27 is provided above the clean tank 25. The secondary filtration section 27 is provided with a back filter 28 for secondary filtration processing and a float switch 29 having a float 29A as a sensor that detects a liquid amount of the discharge liquid 14C secondarily filtered in the secondary filtration section 27.

The back filter 28 has a plurality of filters (four filters, i.e., a filter 28A, a filter 28B, a filter 28C, and a filter 28D in the present embodiment) in a plate shape arranged therein in a vertically multistage form, and the filter 28A, the filter 28B, the filter 28C, and the filter 28D pass the discharge liquid 14B, which has been subjected to primary filtration processing, to be supplied from the upstream side of the filter 28A in this order to perform secondary filtration processing. The back filter 28 is formed of a non-woven fabric having stitches of 30 um to 3 um, for example.

In the secondary filtration section 27, when the discharge liquid 14B is supplied to the upstream side of the filter 28A in the back filter 28, the filter 28A, the filter 28B, the filter 28C, and the filter 28D pass the discharge liquid 14B in this order to perform secondary filtration processing, and the filters (the filter 28A, the filter 28B, the filter 28C, and the filter 28D) collect the very small cutting chips that remain in the discharge liquid 14B without being collected by the primary filtration processing in this order. The discharge liquid 14C from which the very small cutting chips have been removed by the secondary filtration processing is discharged to the outside through a flow path 55.

Further, the filters 28A to the filter 28D in the back filter 28 have a structure in which they are respectively independently replaceable and are respectively settable at determined positions of the secondary filtration section 27 when slidably inserted from above along a guide rail not illustrated, for example, while being removable and replaceable, for example, when pulled up to above in a state of being set and the replacement can be repeatedly performed. When the back filter 28 is thus constituted by the filters (28A to 28D) in a plurality of stages that are independently replaceable, if the filters are replaced, only the filter to be required can be replaced while work is continued with the other filters not to be replaced left without stopping processing work, resulting in a simplification in replacement work and an improvement in productivity.

The secondary filtration section 27 is provided with a clean tank pump 30 that supplies the discharge liquid 14B stored in the clean tank 25 to the upstream side of the filter 28A in the back filter 28 in the secondary filtration section 27 through a flow path 56 and valve 32. The clean tank pump (second tank pump) 30 is a supply pump in the present embodiment, for example, a model number 32UPD15Z manufactured by Nikuni Co., Ltd.

The secondary filtration section 27 is provided with a flow path 58 that causes, when the discharge liquid 14C secondarily filtered in the back filter 28 overflows beyond an upper end of a partition wall 27A in the secondary filtration section 27, the discharge liquid 14C that has overflowed to flow and returns the discharge liquid 14C toward the dirty tank 15. The partition wall 27A and the flow path 58 make adjustment such that the discharge liquid 14C in the secondary filtration section 27 is not stored beyond the upper end of the partition wall 27A.

There is provided between the dirty tank 15 and the clean tank 25 a flow path (discharge liquid return line) 57 that causes, when the liquid amount of the discharge liquid 14B stored in the clean tank 25 exceeds a predetermined amount, the discharge liquid 14B in the clean tank 25 to flow toward the dirty tank 15. In the flow path 57, when the discharge liquid 14B in the clean tank 25 exceeds an upper end of a partition wall 57A on the clean tank 25 side, the discharge liquid 14C beyond the partition wall 57A is caused to flow toward the dirty tank 15, to make adjustment such that the liquid in the clean tank 25 is not stored beyond the upper end of the partition wall 57A.

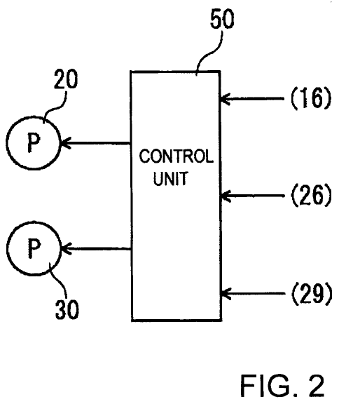

FIG. 2 is a block diagram illustrating an example of a control system that controls continuous operation and temporary operation stop, i.e., operation and stop of the dirty tank pump 20 and the clean tank pump 30. In FIG. 2, the control system includes the control unit 50 and the dirty tank pump 20, the clean tank pump 30, the float switch 16, the float switch 26, the float switch 29, and the like that are connected to the control unit 50.

The control unit 50 is constituted by a CPU, a memory, and the like, for example, and controls the operation and the stop of the dirty tank pump 20 and the clean tank pump 30 according to a procedure by software previously incorporated and on the basis of respective on-off signals from the sensors that detect the liquid amounts, such as the float switch 16, the float switch 26, or the float switch 29, to perform control such that the liquid amount (the discharge liquid 14A) in the dirty tank 15, the liquid amount (the discharge liquid 14B) in the clean tank 25, and the liquid amount (the discharge liquid 14C) in the secondary filtration section 27 are each properly kept.

An operation of the filtration system 10 will be described with reference to FIGS. 1 and 2. The discharge liquid 14A into which the cutting chips or the like generated in the processing chamber 12 are mixed is fed toward the processing discharge liquid filtration device 11 through the flow path 51, the three-way valve 13, and the flow path 51B, and is stored in the dirty tank 15. The liquid amount of the discharge liquid 14A stored in the dirty tank 15 is monitored by the float switch 16. When the liquid amount of the discharge liquid 14A is within a predetermined liquid amount range, the dirty tank pump 20 is continuously driven. The discharge liquid 14A stored in the dirty tank 15 is pumped up by the dirty tank pump 20, and is caused to flow onto the screen filter 18 in the primary filtration section 17 through the flow path 53.

A part of the discharge liquid 14A caused to flow into the flow path 53 is caused to flow into the branch flow path 53A via the open-close valve 23, and a part of the discharge liquid 14A is showered onto the outer surface of the dirty tank pump 20, to cool the inside of the dirty tank pump 20 that has risen in temperature by continuous operation from outside.

A part of the discharge liquid 14A caused to flow into the flow path 53 is caused to flow into the branch flow path 53B via the open-close valve 24, and a part of the discharge liquid 14A is returned to a portion of the intermediate layer that stores the discharge liquid 14A in the dirty tank 15, to agitate the discharge liquid in the display tank 15 by the flow of the returned discharge liquid 14A. By this agitation, lightweight resin or the like to be collected on the liquid surface of the discharge liquid 14A is drawn into liquid water, while the cutting chips submerged on the bottom surface of the dirty tank 15 are suspended in the liquid and are sucked into the flow path 53 by the dirty tank pump 20.

On the other hand, in the discharge liquid 14A fed to the primary filtration section 17 and caused to flow onto the screen filter 18, the coarse cutting chips mixed into the discharge liquid 14A are collected on the screen filter 18 and are left. Only the discharge liquid 14B from which the coarse cutting chips are removed is fed into the clean tank 25 through the flow path 52 and is stored therein. On the other hand, the coarse cutting chips removed by the screen filter 18 slip down into the cutting chip recovery container 19 arranged below by inclination of the screen filter 18 and are recovered therein. The coarse cutting chips recovered into the cutting chip recovery container 19 are periodically recovered and processed.

On the other hand, on the clean tank 25 side, the discharge liquid 14B stored in the clean tank 25 is monitored by the float switch 26. When the liquid amount of the discharge liquid 14B is within a predetermined liquid amount range, the clean tank pump 30 is driven. The discharge liquid 14B stored in the clean tank 25 is pumped up by the clean tank pump 30, and is fed to the secondary filtration section 27 through the flow path 56. In the secondary filtration section 27, the discharge liquid 14B is supplied to the upstream side of the back filter 28, i.e., to the upstream side of the filter 28A. The filter 28A, the filter 28B, the filter 28C, and the filter 28D in the back filter 28 pass the discharge liquid 14B fed to the secondary filtration section 27 in this order. The discharge liquid 14B changes into the clean discharge liquid 14C after the very small cutting chips that have not been collected by primary filtration processing are collected by the back filter 28 and are removed. The discharge liquid 14C is discharged to the outside through the flow path 55. The very small cutting chips collected by the back filter 28 are removed by periodically replacing the filter 28A, the filter 28B, the filter 28C, and the filter 28D in the back filter 28.

Therefore, in the processing discharge liquid filtration device 11 according to the present embodiment, the cutting chips collected by the screen filter 18 can be automatically recovered into the cutting chip recovery container 19 from the screen filter 18. Accordingly, the screen filter 18 need not be maintained at a high frequency, resulting in an improvement in productivity. This makes it possible to enhance a filtration capacity for filtering the discharge liquid 14A to be discharged from the processing chamber 12 to eliminate a time and effort required to replace a filtration member (the screen filter 18 and the back filter 28) and to keep the quality of the discharge liquid subjected to filtration processing constant.

It should be understood that various modifications can be made without departing from the spirit of the prevent invention and the present invention covers the modifications.

### REFERENCE SIGNS LIST

10: filtration system
11: processing discharge liquid filtration device
11A: dirty filtration section
11B: clean filtration section
13: three way valve
14A, 14B, 14C: discharge liquid
15: dirty tank (first tank)
16, 26, 29: float switch (sensor)
16A, 26A, 29A: float
17: primary filtration section
18: screen filter
19: cutting chip recovery container
20: dirty tank pump (first tank pump)
21: open close valve
22: check valve
23: open close valve
24: open close valve
25: clean tank (second tank)
27: secondary filtration section
27A: partition wall
28: back filter
28A, 28B, 28C, 28D: filters
30: clean tank pump (second tank pump)
32: valve
50: control unit
51: middle flow path
51A, 51B: flow path
52, 53, 54, 55, 57: flow path
53A, 53B: branch flow path
57A: partition wall
59: discharge liquid agitation means

What is claimed is:

1. A processing discharge liquid filtration device that filters a discharge liquid containing cutting chips discharged from a processing device, the processing discharge liquid filtration device comprising:
a first tank that stores the discharge liquid;
a first tank pump that pumps up the discharge liquid stored in the first tank;
a screen filter for primary filtration processing that recovers the cutting chips mixed into the discharge liquid to be supplied from the first tank pump; and
a cutting chip recovery container that contains the cutting chips recovered by the screen filter.

2. The processing discharge liquid filtration device according to claim 1, further comprising:
discharge liquid agitation means for returning a part of the discharge liquid pumped up by the first tank pump into the discharge liquid in the first tank to agitate the discharge liquid in the first tank.

3. The processing discharge liquid filtration device according to claim 1, further comprising:
a pump cooling flow path that showers a part of the discharge liquid pumped up by the first tank pump onto an outer surface of the first tank pump.

4. The processing discharge liquid filtration device according to claim 1, further comprising:
a sensor that detects an amount of the discharge liquid in the first tank, and
a control unit that controls operation and stop of the first tank pump on the basis of a signal from the sensor.

5. The processing discharge liquid filtration device according to claim 1, further comprising:
a second tank that stores the discharge liquid, which has been subjected to primary filtration processing, to be discharged from the first tank side,
a back filter for secondary filtration processing that passes the discharge liquid stored in the second tank and recovers smaller cutting chips mixed into the discharge liquid, and
a second tank pump that pumps up the discharge liquid stored in the second tank and supplies the discharge liquid to the upstream side of the back filter.

6. The processing discharge liquid filtration device according to claim 5, further comprising:
a second sensor that detects an amount of the discharge liquid in the second tank, and
a control unit that controls stop of operation of the second tank on the basis of a signal from the second sensor.

7. The processing discharge liquid filtration device according to claim 5, further comprising:
a discharge liquid return line that returns the discharge liquid in the second tank to the first tank when an amount of the discharge liquid in the second tank exceeds a predetermined amount.

8. The processing discharge liquid filtration device according to claim 5, wherein:
the back filter includes filters in a plurality of stages that filter and sequentially pass the discharge liquid, and the filters in the stages are respectively configured to be independently replaceable.
